(19) United States
(12) Patent Application Publication
(10) Pub. No.: US 2015/0293627 A1
(43) Pub. Date: Oct. 15, 2015

(54) TOUCH INPUT APPARATUS, METHOD OF DETECTING TOUCH INPUT, AND COORDINATE INDICATING APPARATUS

(71) Applicant: SAMSUNG ELECTRONICS CO., LTD., Suwon-si (KR)

(72) Inventor: Sung-soo PARK, Suwon-si (KR)

(73) Assignee: SAMSUNG ELECTRONICS CO., LTD., Suwon-si (KR)

(21) Appl. No.: 14/683,552

(22) Filed: Apr. 10, 2015

(30) Foreign Application Priority Data
Apr. 10, 2014 (KR) 10-2014-0043184

(51) Int. Cl. G06F 3/044; G06F 3/01; G09G 5/00

(52) U.S. Cl. CPC G06F 3/044; G09G 5/003; G06F 3/017; G09G 2370/16

(57) ABSTRACT

Provided are a method and an apparatus for detecting a touch input. The method includes: determining a contact position, on a touchscreen, of a coordinate indicating apparatus by detecting a change in an electricity-storing device, the change being caused by a contact between the coordinate indicating apparatus and the touchscreen; and obtaining identification information of the coordinate indicating apparatus by transmitting an electromagnetic signal, as an energy source, to the coordinate indicating apparatus.

### CROSS-REFERENCE TO RELATED APPLICATION

This application claims priority from Korean Patent Application No. 10-2014-0043184, filed on Apr. 10, 2014 in the Korean Intellectual Property Office, the disclosure of which is incorporated herein in its entirety by reference.

### BACKGROUND

1. Field

Apparatuses and methods consistent with one or more exemplary embodiments relate to a touch input apparatus, a method of detecting a touch input, and a coordinate indicating apparatus.

2. Description of the Related Art

Recently, touch input apparatuses that are used for various functions, such as wireless Internet connectivity, electronic organizing, multimedia content reproduction, image capturing, gaming, and the like, have become popular. Examples of the touch input apparatuses include tablet personal computers (PCs), smartphones, portable multimedia player (PMP), personal digital assistants (PDAs), etc. Also, various data input apparatuses have been requested by users. In addition, touchscreens including both an input terminal and a display unit as one apparatus have been widely applied in touch input apparatuses. Capacitive overlay methods, resistive overlay methods, surface acoustic wave methods, transmitter methods, infrared beam methods, and the like are used to drive touchscreens. As use of touchscreens has increased, demand for touch input apparatuses that allow touch inputs of various types have also increased.

### SUMMARY

Aspects of one or more exemplary embodiments provide an apparatus and method of recognizing a kind of a coordinate indicating apparatus when various coordinate indicating apparatuses are used.

Aspects of one or more exemplary embodiments include an apparatus and method of recognizing rotation, direction, and the like of a coordinate indicating apparatus. Additional aspects will be set forth in part in the description which follows and, in part, will be apparent from the description, or may be learned by practice of the presented exemplary embodiments.

According to an aspect of an exemplary embodiment, there is provided a method of detecting a touch input, the method including: determining a contact position, on a touchscreen, of a coordinate indicating apparatus by detecting a change in an electricity-storing device, the change being caused by a contact between the coordinate indicating apparatus and the touchscreen; and obtaining identification information of the coordinate indicating apparatus by transmitting an electromagnetic signal, as an energy source, to the coordinate indicating apparatus.

The obtaining the identification information may include obtaining the identification information by recognizing information on an electronic tag included in the coordinate indicating apparatus.

The method may further include recognizing a rotation direction of the coordinate indicating apparatus based on relative contact positions of at least two conductive contact portions included in the coordinate indicating apparatus.

The method may further include: recognizing the rotation direction of the coordinate indicating apparatus by recognizing a pattern of changes in the electricity-storing device when the at least two conductive contact portions come into contact with the touchscreen, wherein at least one of the at least two conductive contact portions included in the coordinate indicating apparatus has a different size from remaining conductive contact portions of the at least two conductive contact portions included in the coordinate indicating apparatus.

The method may further include: sensing a rotation direction of the coordinate indicating apparatus based on an asymmetric shape of the change in the electricity-storing device that occurs when a conductive contact portion of the coordinate indicating apparatus comes into contact with the touchscreen, wherein the conductive contact portion is an asymmetrical conductive contact portion.

The method may further include: determining if the coordinate indicating apparatus is placed at a position on the touchscreen that is predefined with respect to the coordinate indicating apparatus; and when the coordinate indicating apparatus is determined to be placed at the predefined position on the touchscreen, displaying image content corresponding to the coordinate indicating apparatus at the predefined position on the touchscreen.

The method may further include: displaying image content corresponding to the coordinate indicating apparatus at a position of the touchscreen where the coordinate indicating apparatus is placed; and as the coordinate indicating apparatus moves, moving the image content to a position where the coordinate indicating apparatus is moved.

The method may further include: assigning a sequence number to the coordinate indicating apparatus; and selectively driving the coordinate indicating apparatus according to the assigned sequence number.

The method may further include obtaining additional information about the coordinate indicating apparatus by recognizing a pattern of a conductive contact portion included in the coordinate indicating apparatus when the coordinate indicating apparatus contacts the touchscreen.

According to an aspect of another exemplary embodiment, there is provided a touch input apparatus including: a panel portion combined with a display and configured to sense touch information; and a touch input apparatus controller configured to: determine a contact position of a coordinate indicating apparatus with the panel portion by detecting a change in an electricity-storing device that occurs in the panel portion due to a contact with the coordinate indicating apparatus, and obtain identification information on the coordinate indicating apparatus by transmitting an electromagnetic signal, as an energy source, to the coordinate indicating apparatus via the panel portion.

The touch input apparatus controller may be configured to obtain the identification information by recognizing information on an electronic tag included in the coordinate indicating apparatus.

The apparatus may further include an image processor configured to: determine if the coordinate indicating apparatus is placed at a position on the panel portion that is predefined with respect to the coordinate indicating apparatus; and output for display image content corresponding to the coordinate indicating apparatus at the predefined position when the coordinate indicating apparatus is determined to be placed at the predefined position on the panel portion.

The touch input apparatus controller may be further configured to: determine a sequence number to be recorded in the coordinate indicating apparatus; transmit a response request signal that requests the coordinate indicating apparatus having the sequence number to provide a response; and detect a response signal transmitted from the coordinate indicating apparatus having the sequence number in response to the transmitted response request signal.

The panel portion may include a radio frequency (RF) transceiver configured to transceive an RF signal; the RF transceiver may include an antenna portion configured to receive an electromagnetic signal generated by the coordinate indicating apparatus and an RF transceiving controller configured to measure a signal received by the antenna portion; and the RF transceiving controller may be configured to transmit, via the antenna portion, a sequence number to be recorded in the coordinate indicating apparatus and a response request signal that requests the coordinate indicating apparatus having the sequence number to generate a response, to cause the coordinate indicating apparatus to change a state function thereof according to the sequence number and to determine a delay between the response request signal and a response signal, responsive to the response request signal, according to the state function.

When the coordinate indicating apparatus comes into contact with the panel portion and then moves thereon, a state function of the coordinate indicating apparatus may be maintained while the coordinate indicating apparatus moves on the panel portion.

When the coordinate indicating apparatus comes into contact with the touch input apparatus, separates from the touch input apparatus, and approaches the touch input apparatus again after a predetermined time, the coordinate indicating apparatus may generate the identification information.

The touch input apparatus controller may be further configured to obtain additional information on the coordinate indicating apparatus by recognizing a pattern of a conductive contact portion included in the coordinate indicating apparatus when the coordinate indicating apparatus contacts the touchscreen.

According to an aspect of another exemplary embodiment, there is provided a coordinate indicating apparatus configured to provide a touch input on a touch input apparatus, the coordinate indicating apparatus including: a coordinate indicating apparatus controller configured to provide identification information of the coordinate indicating apparatus based on an electromagnetic signal, as an energy source, transmitted from the touch input apparatus; and at least one conductive contact portion on a side of the coordinate indicating apparatus that contacts a touchscreen of the touch input apparatus when the coordinate indicating apparatus contacts the touchscreen.

The at least one conductive contact portion may include two or more conductive contact portions, and at least one of the two or more conductive contact portions may have a different size from other conductive contact portions of the two or more conductive contact portions.

The apparatus may further include an electronic tag configured to transmit an electromagnetic signal indicating the identification information to the touch input apparatus based on the electromagnetic signal, as the energy source, transmitted from the touch input apparatus.

A pattern of the at least one conductive contact portion may indicate, to the touch input apparatus, additional information on the coordinate indicating apparatus when the at least one conductive contact portion contacts the touchscreen.

According to an aspect of another exemplary embodiment, there is provided a method of providing a touch input by a coordinate indicating apparatus on a touch input apparatus, the method including: providing, to the touch input apparatus, identification information of the coordinate indicating apparatus based on an electromagnetic signal, as an energy source, transmitted from the touch input apparatus; and contacting, by at least one conductive contact portion on a side of the coordinate indicating apparatus, a touchscreen of the touch input apparatus.

The at least one conductive contact portion may include two or more conductive contact portions, and at least one of the two or more conductive contact portions may have a different size from other conductive contact portions of the two or more conductive contact portions.

The providing the identification information may include transmitting, by an electronic tag of the coordinate indicating apparatus, an electromagnetic signal indicating the identification information to the touch input apparatus based on the electromagnetic signal, as the energy source, transmitted from the touch input apparatus.

A pattern of the at least one conductive contact portion may indicate, to the touch input apparatus, additional information on the coordinate indicating apparatus when the at least one conductive contact portion contacts the touchscreen.

### BRIEF DESCRIPTION OF THE DRAWINGS

These and/or other aspects will become apparent and more readily appreciated from the following description of exemplary embodiments, taken in conjunction with the accompanying drawings in which:

FIG. 1 illustrates a touch input apparatus and a coordinate indicating apparatus according to an exemplary embodiment;

FIG. 2 illustrates a structure of a touch input apparatus according to an exemplary embodiment;

FIG. 3 illustrates a flowchart of a method of detecting a touch input according to an exemplary embodiment;

FIG. 4A illustrates a perspective view of a coordinate indicating apparatus according to an exemplary embodiment, and FIG. 4B illustrates a side of the coordinate indicating apparatus of FIG. 4A that faces a touchscreen of the touch input apparatus of FIG. 1;

FIG. 5 illustrates a side of a coordinate indicating apparatus according to another exemplary embodiment that faces the touchscreen of the touch input apparatus of FIG. 1;

FIG. 6 illustrates a configuration for recognizing a rotation of the coordinate indicating apparatus of FIG. 5, according to another exemplary embodiment;

FIG. 7 illustrates a side of a coordinate indicating apparatus according to another exemplary embodiment that faces the touchscreen of the touch input apparatus of FIG. 1;

FIG. 8 illustrates a configuration for recognizing a rotation of the coordinate indicating apparatus of FIG. 7, according to another exemplary embodiment;

FIG. 9 illustrates a side of a coordinate indicating apparatus according to another exemplary embodiment that faces a touchscreen of the touch input apparatus of FIG. 2;

FIG. 10 illustrates a structure of a touch input apparatus according to another exemplary embodiment;

FIG. 11 illustrates an example of providing image content corresponding to the coordinate indicating apparatus of FIG. 1, according to another exemplary embodiment;

FIG. 12 illustrates an example of providing image content corresponding to the coordinate indicating apparatus of FIG. 1, according to another exemplary embodiment;

FIG. 13 illustrates an example of providing image content corresponding to the coordinate indicating apparatus of FIG. 1, according to another exemplary embodiment;

FIG. 14 illustrates an example of changing an image in response to a movement of a coordinate indicating apparatus, according to another exemplary embodiment;

FIG. 15 illustrates a structure of a panel portion according to another exemplary embodiment; and

FIG. 16 illustrates a flowchart of a method of detecting a touch input according to another exemplary embodiment.

### DETAILED DESCRIPTION

The following description and the accompanying drawings are provided for a better understanding of exemplary embodiments, and descriptions of techniques or structures related to exemplary embodiments that would be obvious to one of ordinary skill in the art will be omitted.

Also, the present specification and the drawings are not intended to limit all exemplary embodiments, and exemplary embodiments should be defined by the scope of the appended claims. The meaning of the terms used in the specification should be construed as concepts not departing from the technical scope of the inventive concept in order to describe the inventive concept in the most appropriate way.

Reference will now be made in detail to exemplary embodiments, examples of which are illustrated in the accompanying drawings, wherein like reference numerals refer to like elements throughout. Expressions such as “at least one of,” when preceding a list of elements, modify the entire list of elements and do not modify the individual elements of the list.

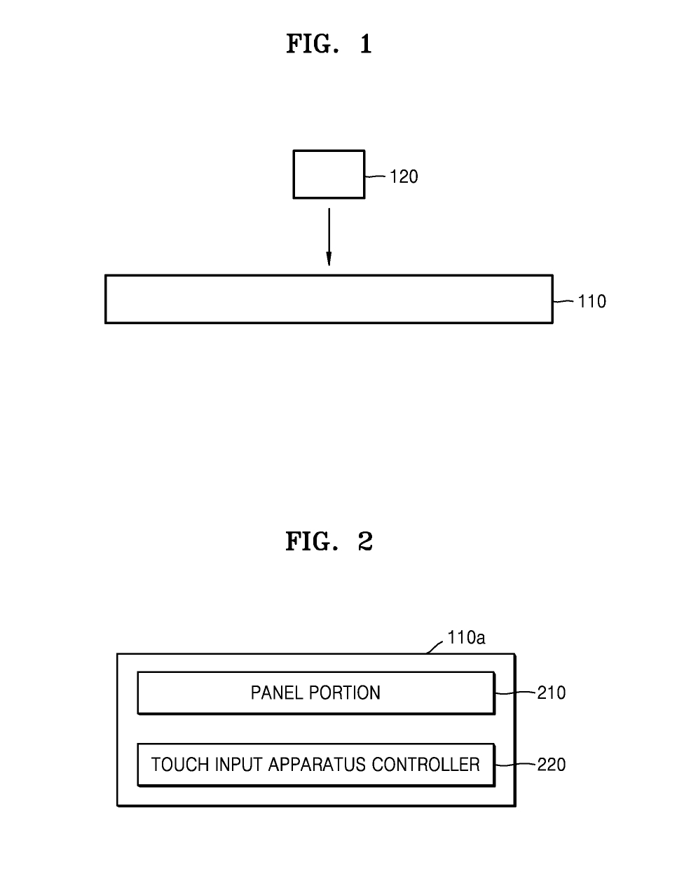

FIG. 1 illustrates a touch input apparatus 110 and a coordinate indicating apparatus 120 according to an exemplary embodiment.

The touch input apparatus 110 includes a touchscreen controllable by a user through a touch input. The touchscreen may receive a touch input according to a contact with a body part or the coordinate indicating apparatus 120. The touchscreen according to the present exemplary embodiment may be a capacitive overlay touchscreen, although it is understood that one or more other exemplary embodiments are not limited thereto. The touch input apparatus 110 may be, for example, a tablet personal computer (PC), a smartphone, a portable multimedia player (PMP), a laptop personal computer, a monitor, a PC, a personal digital assistant (PDA), and the like.

The coordinate indicating apparatus 120 provides a touch input to the touch input apparatus 110 by contact with the touchscreen of the touch input apparatus 110. For example, the coordinate indicating apparatus 120 may include a conductive contact portion such that when the conductive contact portion comes into contact with the coordinate indicating apparatus 120, the coordinate indicating apparatus 120 may provide a touch input to the touch input apparatus 110 that uses a capacitive overlay method. The coordinate indicating apparatus 120 may be, for example, a teaching tool, a doll, a toy, a touch pen, a stylus, and the like.

FIG. 2 illustrates a structure of a touch input apparatus 110a according to an exemplary embodiment. The touch input apparatus 110a according to the present exemplary embodiment includes a panel portion 210 and a touch input apparatus controller 220.

The panel portion 210 detects a touch input. For example, the panel portion 210 may detect a position of the touch input by sensing a change in capacitance according to the touch input. The panel portion 210 may be in a form of an array of sensing patterns in which sensing patterns for sensing a change in capacitance are arranged in a matrix form. When a part of a human body or the conductive contact portion of the coordinate indicating apparatus 120 comes into contact with the panel portion 210, a signal generated by the sensing patterns corresponding to a position where the contact with the panel portion 210 occurs is transmitted to a touch driving circuit. Thus, x-axis position information and y-axis position information on the touch input may be determined. The panel portion 210 may include a touch input detecting unit (e.g., touch input detector) that includes a transparent conductive layer and a display unit (e.g., display) configured to display images. The touch input detecting unit may be placed on the display unit.

The panel portion 210 also displays image content. The panel portion 210, for example, may include a liquid crystal display (LCD), an organic light-emitting diode (OLED) panel, an active matrix OLED (AMOLED) panel, an electrophoretic display panel, etc.

The panel portion 210 may be in a form of a touchscreen.

The touch input apparatus controller 220 obtains identification information by recognizing the identification information provided by the coordinate indicating apparatus 120.

According to an exemplary embodiment, the identification information is provided by an electronic tag included in the coordinate indicating apparatus 120. The electronic tag may be, for example, a radio frequency identification (RFID) tag, a near field communication (NFC) tag, or the like. In this case, the touch input apparatus controller 220 may be a communication module (e.g., communicator) or an antenna used to recognize information recorded on the electronic tag. For example, the touch input apparatus controller 220 may be a radio frequency (RF) signal transceiver configured to transceive an RF signal or an NFC signal transceiver configured to transceive an NFC signal. The RF signal transceiver and the NFC signal transceiver may include, for example, an antenna for receiving an electromagnetic signal generated by the coordinate indicating apparatus 120 and a processor for applying an electrical signal to the antenna and measuring the electrical signal.

According to another exemplary embodiment, additional information may be provided by a pattern of the conductive contact portion included in the coordinate indicating apparatus 120. According to the present exemplary embodiment, identification information on the coordinate indicating apparatus 120 is provided by the electronic tag, and auxiliary information on the coordinate indicating apparatus 120 may be provided by the pattern of the conductive contact portion. The auxiliary information may be, for example, attribute information on the coordinate indicating apparatus 120, such as information indicating if the coordinate indicating apparatus 120 is a toy car or a doll or indicating if the coordinate indicating apparatus 120 is a red pen or a blue pen.

The pattern of the conductive contact portion may be expressed by at least one of information on a distance between two or more conductive contact portions (e.g., two conductive contact portions included in the coordinate indicating apparatus 120), information on a size of the conductive contact portion, information on a relative position of the conductive contact portion, or a combination thereof. According to the present exemplary embodiment, the touch input apparatus controller 220 may obtain auxiliary identification information on the coordinate indicating apparatus 120 by using touch input information obtained from the panel portion 210.

The touch input apparatus controller 220 processes position information, size information, and identification information on the touch input detected by the panel portion 210.

According to one or more exemplary embodiments, identification information may be obtained by using an electromagnetic signal of the coordinate indicating apparatus 120. Thus, when touch inputs are input from various coordinate indicating apparatuses 120, a kind (e.g., type) of the coordinate indicating apparatus 120 may be differentiated from another or the coordinate indicating apparatuses 120 may be identified. In the case that touch inputs are input at the same time from a plurality of coordinate indicating apparatuses 120, an operation of the touch input apparatus 110a may be controlled by each of the touch inputs.

According to an exemplary embodiment, while the coordinate indicating apparatus 120 moves, the touch input apparatus controller 220 may maintain identification information of the coordinate indicating apparatus 120 that is determined by the initial touch. According to the present exemplary embodiment, by tracking a touch input via the coordinate indicating apparatus 120 and matching the identification information determined by the initial touch to the touch input via the coordinate indicating apparatus 120, identification information may be obtained from the initial touch (and not subsequent touches) and a process of obtaining the identification information may be omitted thereafter.

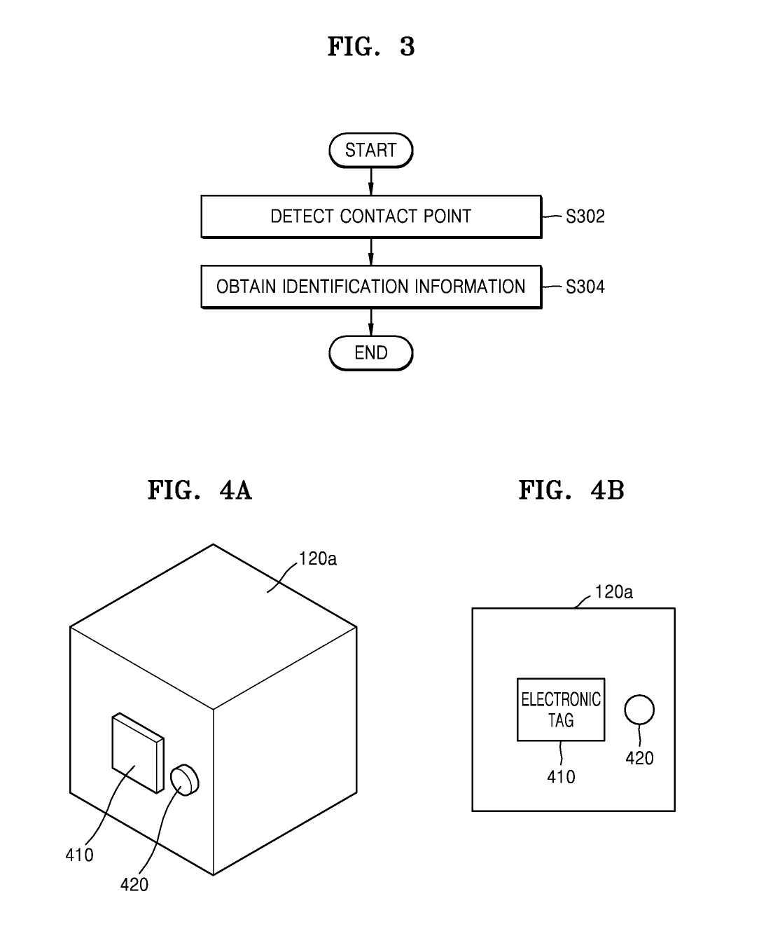

FIG. 3 illustrates a flowchart of a method of detecting a touch input according to an exemplary embodiment.

Referring to FIG. 3, in operation S302, when a touch input is detected, the touch input apparatus 110 detects a contact point of the touch input. For example, the touch input apparatus 110 may detect the contact point by detecting a change in an electricity-storing device.

In operation S304, if the touch input is detected, the touch input apparatus 110 obtains identification information from the coordinate indicating apparatus 120. The identification information may be obtained from an electronic tag included in the coordinate indicating apparatus 120. Also, the touch input apparatus 110 may obtain auxiliary identification information from a pattern of a conductive contact portion included in the coordinate indicating apparatus 120. The touch input apparatus 110 may, although not necessarily, compare the pattern of the conductive contact portion to predetermined data to obtain the auxiliary information.

FIG. 4A illustrates a perspective view of a coordinate indicating apparatus 120a according to an exemplary embodiment, and FIG. 4B illustrates a side of the coordinate indicating apparatus 120a that faces the touchscreen of the touch input apparatus 110. The coordinate indicating apparatus 120a according to the present embodiment includes an electronic tag 410 and a conductive contact portion 420.

The electronic tag 410 is a tag that provides identification information on the coordinate indicating apparatus 120a. When the electronic tag 410 is close to the touch input apparatus 110 (e.g., within a range of a signal transmission from the touch input apparatus 110), the electronic tag 410 receives a signal that is provided by the touch input apparatus 110 and generates a signal that indicates information stored in the electronic tag 410. The electronic tag 410 may be, for example, an RFID tag, an NFC tag, or the like.

The conductive contact portion 420 includes a conductive material and has a predefined shape, size, and position. When the conductive contact portion 420 comes into contact with a panel portion 210 of the touch input apparatus 110a, an electricity-storing device of an area where the conductive portion 420 comes into contact with the touch detector 210 changes and a touch input is detected from the panel portion 210 of the touch input apparatus 110a.

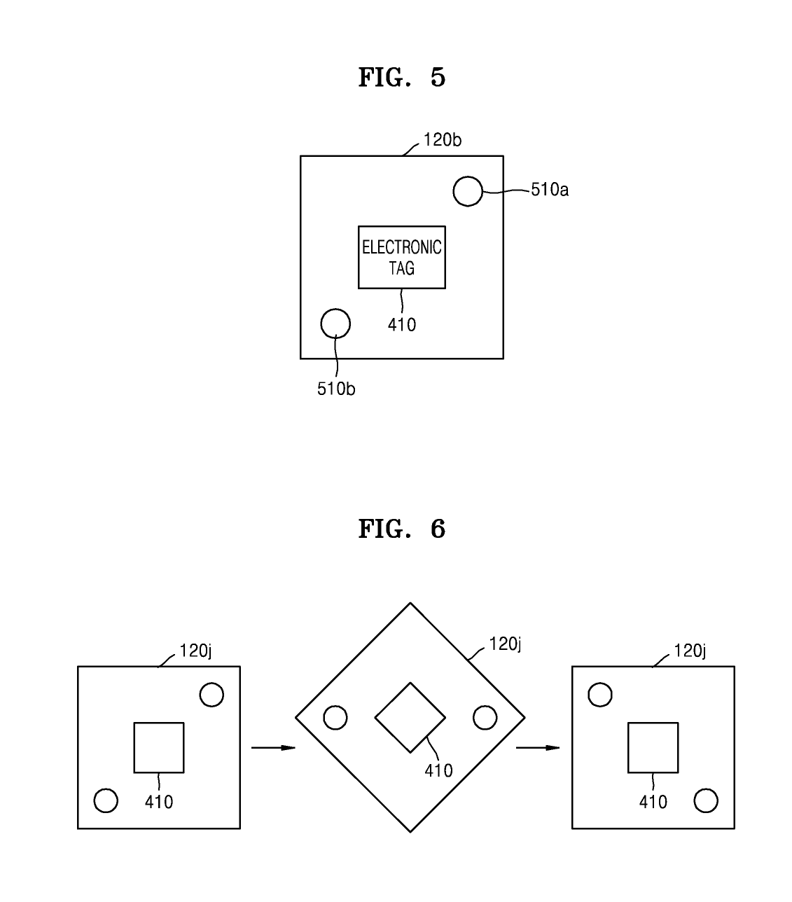

FIG. 5 illustrates a side of a coordinate indicating apparatus 120b according to another exemplary embodiment that faces the touchscreen of the touch input apparatus 110. The coordinate indicating apparatus 120b according to the present exemplary embodiment includes an electronic tag 410 and two conductive contact portions 510a and 510b.

As the coordinate indicating apparatus 120b according to the present exemplary embodiment includes the two conductive contact portions 510a and 510b, the touch input apparatus 110 may sense rotation of the coordinate indicating apparatus 120b. Although the coordinate indicating apparatus 120b illustrated in FIG. 5 includes the two conductive contact portions 510a and 510b, it is understood that one or more other exemplary embodiments are not limited thereto. For example, according to one or more other exemplary embodiments, the coordinate indicating apparatus 120b may include two or more conductive contact portions 510a and 510b.

FIG. 6 illustrates a configuration for recognizing a rotation of a coordinate indicating apparatus 120j according to another exemplary embodiment.

According to the present exemplary embodiment, rotation of the coordinate indicating apparatus 120j may be recognized by detecting positions of a plurality of conductive contact portions. As illustrated in FIG. 6, if the coordinate indicating apparatus 120j includes two conductive contact portions of the same size, a rotation of the coordinate indicating apparatus 120j up to 180 degrees may be sensed.

According to the present exemplary embodiment, a placement direction of the coordinate indicating apparatus 120j may also be recognized by using the two conductive contact portions. For example, the touch input apparatus 110a may recognize if the coordinate indicating apparatus 120j is placed on the touch input apparatus 110a vertically, horizontally, in a 45 degree direction, or in any other direction.

According to the present exemplary embodiment, the touch input apparatus 110a may obtain auxiliary identification information on the coordinate indicating apparatus 120j by using the two conductive contact portions. For example, the touch input apparatus 110a may obtain the auxiliary identification information by detecting relative positions of two conductive contact portions 510a and 510b or a relative position of at least one of the conductive contact portions 510a and 510b with respect to an electronic tag 410.

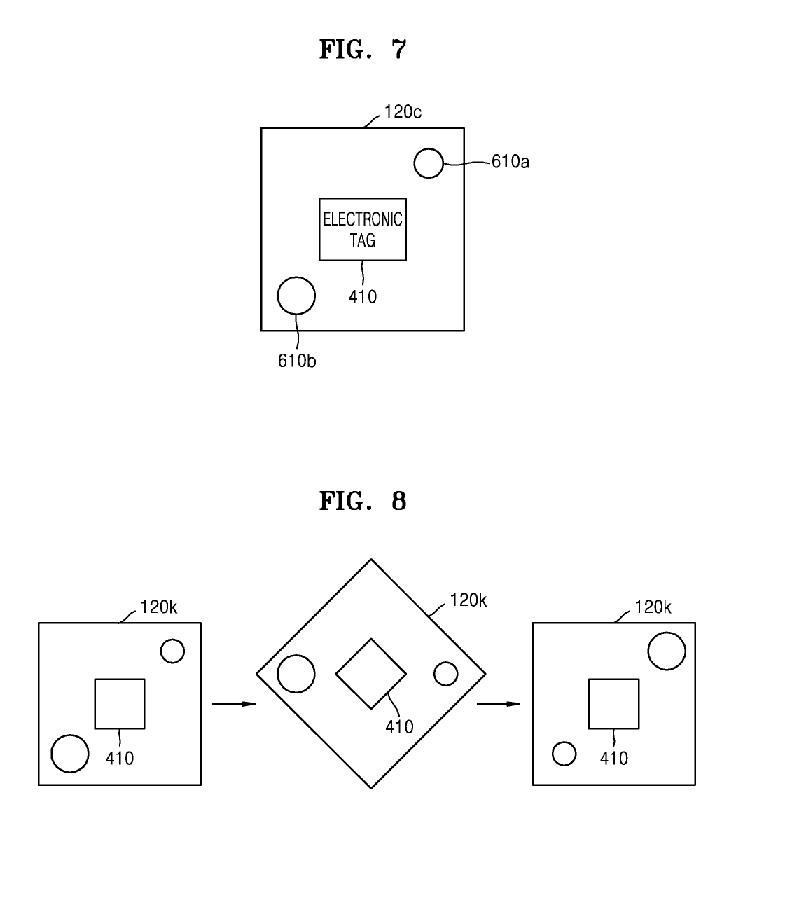

FIG. 7 illustrates a side of a coordinate indicating apparatus 120c according to another exemplary embodiment that faces the touchscreen of the touch input apparatus 110. The coordinate indicating apparatus 120c according to the present exemplary embodiment includes an electronic tag 410 and two conductive contact portions 610a and 610b.

As the coordinate indicating apparatus 120c according to the present exemplary embodiment includes the two conductive contact portions 610a and 610b of different sizes, the touch input apparatus 110 may sense rotation of the coordinate indicating apparatus 120c up to 360 degrees.

FIG. 8 illustrates a configuration for recognizing a rotation of a coordinate indicating apparatus 120k according to another exemplary embodiment.

According to another exemplary embodiment, rotation of the coordinate indicating apparatus 120k may be sensed up to 360 degrees by detecting positions of conductive contact portions of different sizes.

According to the present exemplary embodiment, a placement direction of the coordinate indicating apparatus 120k may also be recognized by using the conductive contact portions of different sizes. For example, the touch input apparatus 110a may recognize if the coordinate indicating apparatus 120k is placed on the touch input apparatus 110a vertically, horizontally, in a 45 degree direction, or in any other direction.

According to the present exemplary embodiment, the touch input apparatus 110a may obtain auxiliary identification information on the coordinate indicating apparatus 120k by using two conductive contact portions. For example, the touch input apparatus 110a may obtain the auxiliary identification information by detecting relative positions of two conductive contact portions 610a and 610b or a relative position of at least one of the conductive contact portions 610a and 610b with respect to an electronic tag 410.

Although the two conductive contact portions 610a and 610b are provided in FIG. 7, one or more other exemplary embodiments provide two or more conductive contact portions 610a and 610b. At least one conductive contact portion of the two or more conductive contact portions 610a and 610b has a different size from the other conductive contact portions of the two or more conductive contact portions 610a and 610b.

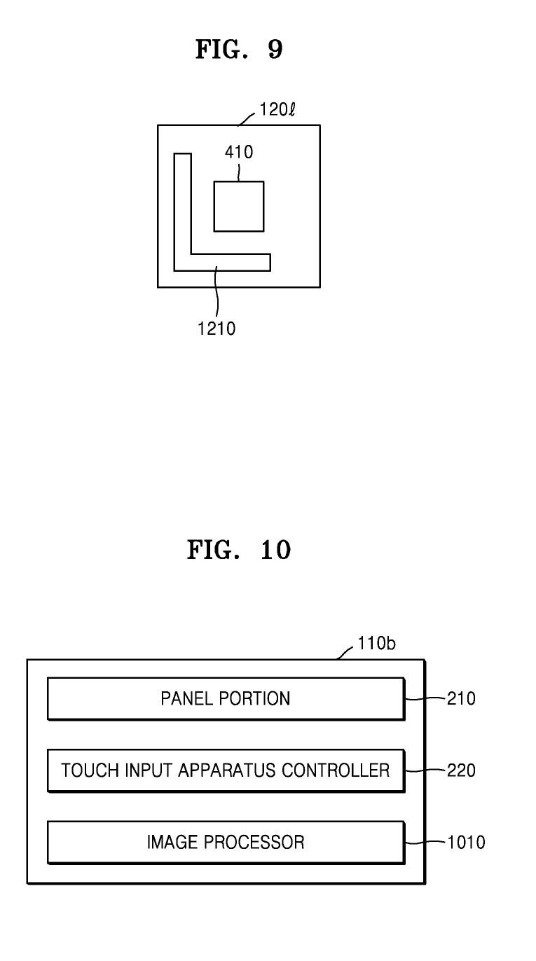

FIG. 9 illustrates a side of a coordinate indicating apparatus 120l according to another exemplary embodiment that faces a touchscreen of the touch input apparatus 110a. The coordinate indicating apparatus 120l according to the present exemplary embodiment includes an electronic tag 410 and a conductive contact portion 1210 having an asymmetric shape.

The touch input apparatus 110a may obtain identification information on the coordinate indicating apparatus 120l from the electronic tag 410.

According to the present exemplary embodiment, rotation of the coordinate indicating apparatus 120l and a placement direction of the coordinate indicating apparatus 120l may be sensed by using the asymmetric conductive contact portion 1210.

According to an exemplary embodiment, the conductive contact portion 1210 provides position information on the coordinate indicating apparatus 120l and auxiliary identification information. The auxiliary identification information on the coordinate indicating apparatus 120l may be based on a shape of the conductive contact portion 1210. According to the present exemplary embodiment, the coordinate indicating apparatus 120l may include a plurality of conductive contact portions 1210 having asymmetric shapes.

FIG. 10 illustrates a structure of a touch input apparatus 110b according to another exemplary embodiment. The touch input apparatus 110b according to the present exemplary embodiment includes a panel portion 210, a touch input apparatus controller 220, and an image processor 1010.

The panel portion 210 detects a touch input. For example, the panel portion 210 may detect a position of the touch input by sensing a change in capacitance according to the touch input.

The panel portion 210 also displays image content. The panel portion 210, for example, may include an LCD, an OLED panel, an AMOLED panel, an electrophoretic display panel, etc.

The panel portion 210 may be a touchscreen.

The touch input apparatus controller 220 obtains identification information by recognizing the identification information provided by the coordinate indicating apparatus 120.

The touch input apparatus controller 220 processes position information, size information, and identification information on the touch input detected by the panel portion 210. Also, the touch input apparatus controller 220 provides, to the image processor 1010, the position information, size information, and identification information on the touch input.

The image processor 1010 provides image content corresponding to the coordinate indicating apparatus 120, according to the touch input.

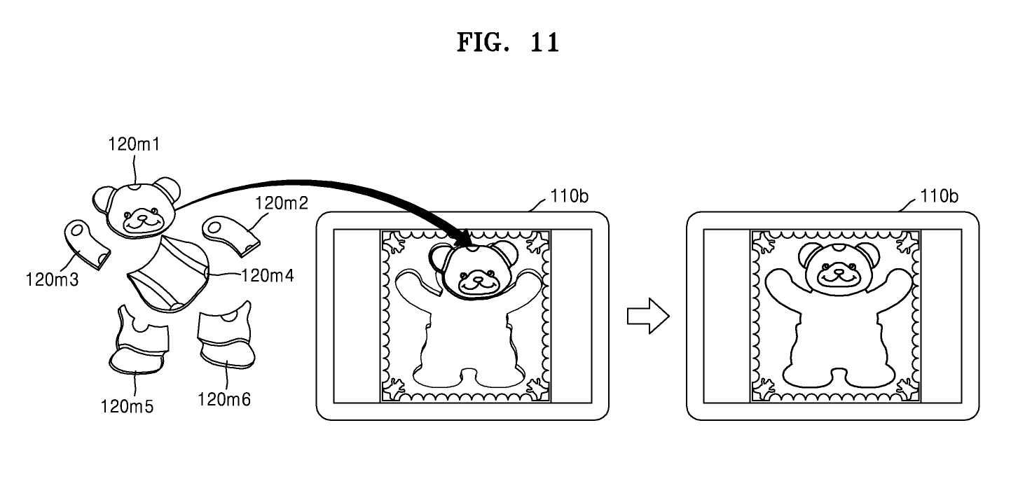

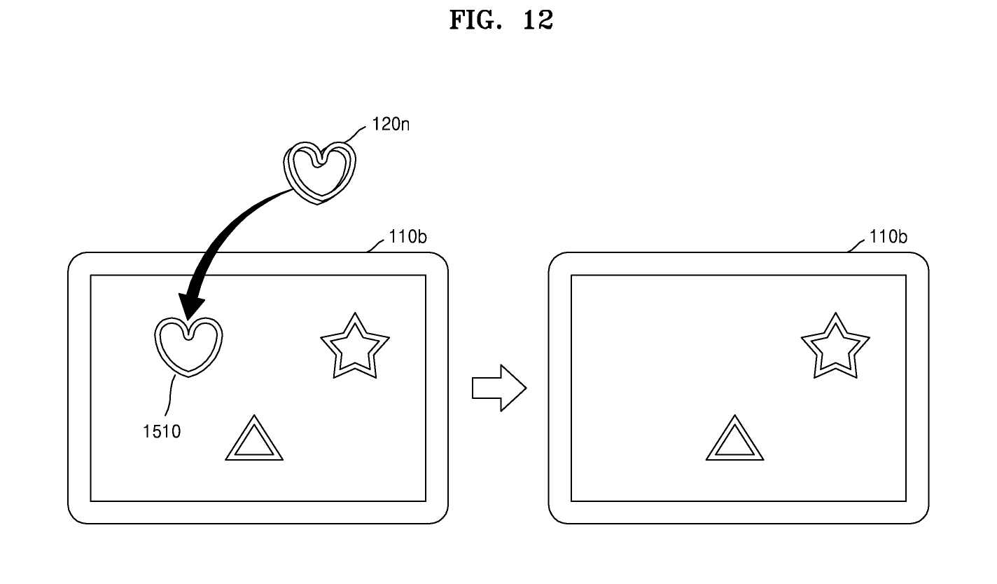

FIG. 11 illustrates an example of providing image content corresponding to the coordinate indicating apparatus 120, according to another exemplary embodiment.

According to the present exemplary embodiment, when a coordinate indicating apparatus 120m1 is placed on a predefined position on a touchscreen of the touch input apparatus 110b, the touch input apparatus 110b displays image content corresponding to the coordinate indicating apparatus 120m1 on the predefined position on the touchscreen. As illustrated in FIG. 11, in the case that a puzzle game is played using coordinate indicating apparatuses 120m1, 120m2, 120m3, 120m4, 120m5, and 120m6, when the coordinate indicating apparatus 120m1 is placed on a predefined position on the panel portion 210 of the touch input apparatus 110b, the image content corresponding to the coordinate indicating apparatus 120m1 may be displayed on the predefined position on the panel portion 210. Accordingly, a user may play the puzzle game by placing each of the coordinate indicating apparatuses 120m1, 120m2, 120m3, 120m4, 120m5, and 120m6 on predefined positions on the panel portion 210 of the touch input apparatus 110b.

FIG. 12 illustrates an example of providing image content corresponding to the coordinate indicating apparatus 120, according to another exemplary embodiment.

According to the present exemplary embodiment, when a coordinate indicating apparatus 120n is placed on a predefined object 1510 on the panel portion 210 of the touch input apparatus 110b, the touch input apparatus 110b may remove the object 1510 from a screen of the touch input apparatus 110b. For example, as illustrated in FIG. 12, a user may play a shape-matching game in which a plurality of moving objects are displayed on the touch input apparatus 110b, and, when the user puts the coordinate indicating apparatus 120n on the predefined object 1510, the object 1510 disappears.

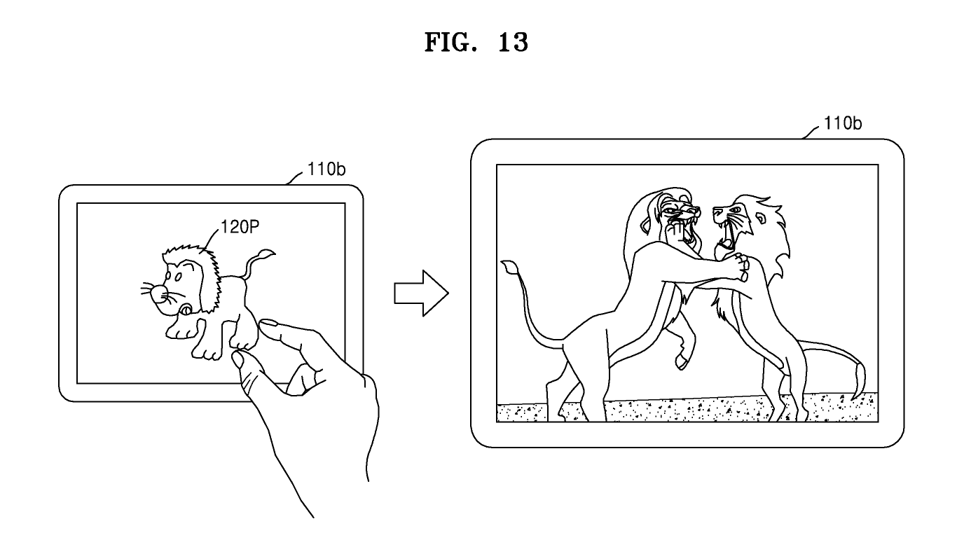

FIG. 13 illustrates an example of providing image content corresponding to the coordinate indicating apparatus 120, according to another exemplary embodiment.

According to the present exemplary embodiment, when a coordinate indicating apparatus 120P is placed on the panel portion 210 of the touch input apparatus 110b, the touch input apparatus 110b may provide image content corresponding to the coordinate indicating apparatus 120P. For example, as illustrated in FIG. 13, when the coordinate indicating apparatus 120P having a lion shape is placed on the panel portion 210 of the touch input apparatus 110b, a moving image of a lion is played and displayed on the panel portion 210. Alternatively, when the touch input apparatus 110b recognizes that two lion-shaped coordinate indicating apparatuses 120P are placed together, the touch input apparatus 110b may provide image content related to two lions (for example, image content in which two lions fight against each other).

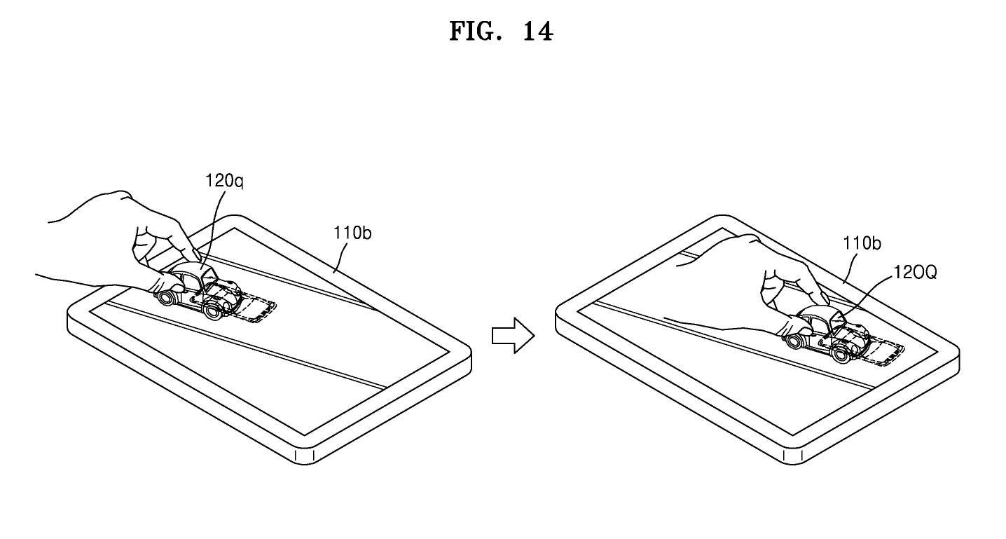

FIG. 14 illustrates an example of changing an image in response to a movement of a coordinate indicating apparatus 120q according to another exemplary embodiment.

According to the present exemplary embodiment, when the movement of the coordinate indicating apparatus 120q on the panel portion 210 of the touch input apparatus 110b is sensed by the touch input apparatus 110b, the touch input apparatus 110b may display an image object corresponding to the coordinate indicating apparatus 120q and may display an image that moves the image object according to the movement of the coordinate indicating apparatus 120q. Further, according to the present exemplary embodiment, the touch input apparatus 110b may rotate the image object or change a placement direction of the image object by recognizing rotation and a placement direction of the coordinate indicating apparatus 120q.

As such, according to one or more exemplary embodiments, various functions according to the coordinate indicating apparatus 120 may be provided by recognizing at least one of a position, identification information, rotation, and a placement direction of the coordinate indicating apparatus 120.

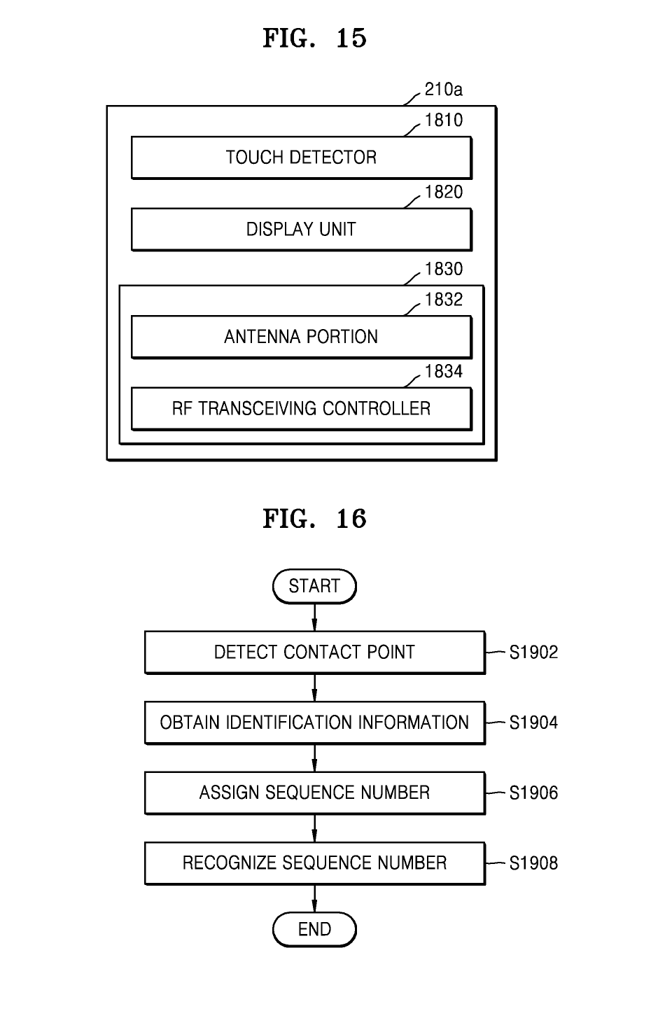

FIG. 15 illustrates a structure of a panel portion 210a according to another exemplary embodiment. The panel portion 210a according to the present exemplary embodiment includes a touch detector 1810, a display unit 1820 (e.g., display), and an RF transceiver 1830.

The touch detector 1810 detects a touch input. For example, the touch detector 1810 may detect a position of the touch input by sensing a change in capacitance according to the touch input.

The display unit 1820 displays image content. The display unit 1820, for example, may be an LCD, an OLED panel, an AMOLED panel, an electrophoretic display panel, or the like.

The touch detector 1810 and the display unit 1820 may compose a touchscreen.

The RF transceiver 1830 obtains identification information by recognizing the identification information provided by the coordinate indicating apparatus 120. The RF transceiver 1830 according to an exemplary embodiment may include an antenna portion 1832 and an RF transceiving controller 1834.

The antenna portion 1832 generates and transmits an electromagnetic signal and receives an electromagnetic signal generated by the coordinate indicating apparatus 120. The antenna portion 1832 may include, for example, a plurality of unit antennas.

The RF transceiving controller 1834 applies an electrical signal to the antenna portion 1832 and measures a signal received by the antenna portion 1832. The RF transceiving controller 1834 may apply the electrical signal to the antenna portion 1832 in order to obtain identification information from the electronic tag 410 included in the coordinate indicating apparatus 120. The antenna portion 1832 transmits an electromagnetic signal to the electronic tag 410 by using the electrical signal applied from the RF transceiving controller 1834, and, by using the electromagnetic signal as an energy source, the electronic tag 410 generates an electromagnetic signal. The antenna portion 1832 receives the electromagnetic signal generated by the electronic tag 410, and the RF transceiving controller 1834 obtains identification information on the coordinate indicating apparatus 120 by measuring the electromagnetic signal received by the antenna portion 1832.

According to an exemplary embodiment, the touch input apparatus controller 220 may generate and output a sequence number (e.g., index value) to be recorded in the coordinate indicating apparatus 120. The coordinate indicating apparatus 120 may receive the sequence number and store the sequence number in a predetermined sequence number storage unit (e.g., sequence number storage). Whenever a new coordinate indicating apparatus is detected, the touch input apparatus controller 220 may generate and output a new sequence number signal and thus assign a different sequence number to the coordinate indicating apparatus 120.

After the touch input apparatus controller 220 generates a response request signal and outputs the response request signal to the coordinate indicating apparatus 120, the touch input apparatus controller 220 detects a response signal to the output response request signal from the coordinate indicating apparatus 120 and thus recognizes the sequence number assigned to the coordinate indicating apparatus 120. For example, the touch input apparatus controller 220 may generate a response request signal to a sequence number 1 and receive a response signal to the sequence number 1 from the coordinate indicating apparatus 120, thereby recognizing the sequence number of the coordinate indicating apparatus 120. When the touch input apparatus 110 recognizes a touch input, after the touch input apparatus 110 outputs a response request signal of a predetermined sequence number and detects a response signal to the predetermined sequence number, the touch input apparatus 110 may detect the touch input by the coordinate indicating apparatus 120 that corresponds to the predetermined sequence number.

According to the present exemplary embodiment, in the case that a plurality of coordinate indicating apparatuses are used, a sequence number may be assigned to each of the coordinate indicating apparatuses to determine an order in which the coordinate indicating apparatuses are used and priorities of the coordinate indicating apparatuses.

According to an exemplary embodiment, the RF transceiving controller 1834 may output an electrical signal to the antenna portion 1832 so as to transmit the sequence number signal and the response request signal. The touch input apparatus controller 220 may output a control signal to the RF transceiving controller 1834 so as to transmit the sequence number signal and the response request signal. Also, the RF transceiving controller 1834 may detect a response signal detected from the antenna portion 1832 and provide a detection result to the touch input apparatus controller 220.

The coordinate indicating apparatus 120 may change a state function of the coordinate indicating apparatus 120 according to a sequence number signal and may change a delay between a response request signal and a response signal according to a sequence number of the coordinate indicating apparatus 120. Based on the delay between the response request signal and the response signal, the touch input apparatus controller 220 may determine the sequence number of the coordinate indicating apparatus 120 corresponding to the output response signal.

FIG. 16 illustrates a flowchart of a method of detecting a touch input according to another exemplary embodiment.

Referring to FIG. 16, in operation S1902, when a touch input is detected, the touch input apparatus 110 detects a contact point. For example, the touch input apparatus 110 may detect the contact point by detecting a change in an electricity-storing device.

In operation S1904, if the touch input is detected, the touch input apparatus 110 obtains identification information from the coordinate indicating apparatus 120. The identification information may be obtained from an electronic tag included in the coordinate indicating apparatus 120.

In operation S1906, the touch input apparatus 110 assigns a sequence number to the coordinate indicating apparatus 120 which has been newly recognized. In order to assign the sequence number, a sequence number signal is output to the coordinate indicating apparatus 120.

In operation S1908, while the touch input by the coordinate indicating apparatus 120 is recognized, the sequence number of the coordinate indicating apparatus 120 is recognized. In order to recognize the sequence number of the coordinate indicating apparatus 120, a response request signal is generated by the touch input apparatus 110 and output, and the sequence number of the coordinate indicating apparatus 120 is recognized based on a response signal output from the coordinate indicating apparatus 120.

As described above, according to one or more exemplary embodiments, an apparatus and a method of recognizing a type of a coordinate indicating apparatus when various coordinate indicating apparatuses are used may be provided.

Also, according to one or more exemplary embodiments, when a position of a coordinate indicating apparatus is measured via a capacitive touch sensor and a type of the coordinate indicating apparatus is recognized based on an electronic tag included therein, the coordinate indicating apparatus may be configured as a passive device without including a power supply.

Furthermore, according to one or more exemplary embodiments, an apparatus and a method of recognizing rotation, direction, and the like of a coordinate indicating apparatus may be provided.

While not restricted thereto, an exemplary embodiment can be embodied as computer-readable code on a computer-readable recording medium. The computer-readable recording medium is any data storage device that can store data that can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network-coupled computer systems so that the computer-readable code is stored and executed in a distributed fashion. Also, an exemplary embodiment may be written as a computer program transmitted over a computer-readable transmission medium, such as a carrier wave, and received and implemented in general-use or special-purpose digital computers that execute the programs. Moreover, it is understood that in exemplary embodiments, one or more units, elements, or components of the above-described apparatuses can include circuitry, a processor, a microprocessor, etc., and may execute a computer program stored in a computer-readable medium.

It should be understood that the exemplary embodiments described herein should be considered in a descriptive sense only and not for purposes of limitation. Descriptions of features or aspects within each exemplary embodiment should typically be considered as available for other similar features or aspects in other exemplary embodiments.

While one or more exemplary embodiments have been described with reference to the figures, it will be understood by those of ordinary skill in the art that various changes in form and details may be made therein without departing from the spirit and scope as defined by the following claims.

What is claimed is:

1. A method of detecting a touch input, the method comprising:
determining a contact position, on a touchscreen, of a coordinate indicating apparatus by detecting a change in an electricity-storing device, the change being caused by a contact between the coordinate indicating apparatus and the touchscreen; and
obtaining identification information of the coordinate indicating apparatus by transmitting an electromagnetic signal, as an energy source, to the coordinate indicating apparatus.

2. The method of claim 1, wherein the obtaining the identification information comprises obtaining the identification information by recognizing information on an electronic tag included in the coordinate indicating apparatus.

3. The method of claim 1, further comprising recognizing a rotation direction of the coordinate indicating apparatus based on relative contact positions of at least two conductive contact portions included in the coordinate indicating apparatus.

4. The method of claim 3, further comprising:
recognizing the rotation direction of the coordinate indicating apparatus by recognizing a pattern of changes in the electricity-storing device when the at least two conductive contact portions come into contact with the touchscreen,
wherein at least one of the at least two conductive contact portions included in the coordinate indicating apparatus has a different size from remaining conductive contact portions of the at least two conductive contact portions included in the coordinate indicating apparatus.

5. The method of claim 1, further comprising:
sensing a rotation direction of the coordinate indicating apparatus based on an asymmetric shape of the change in the electricity-storing device that occurs when a conductive contact portion of the coordinate indicating apparatus comes into contact with the touchscreen,
wherein the conductive contact portion is an asymmetrical conductive contact portion.

6. The method of claim 1, further comprising determining if the coordinate indicating apparatus is placed at a position on the touchscreen that is predefined with respect to the coordinate indicating apparatus; and
when the coordinate indicating apparatus is determined to be placed at the predefined position on the touchscreen, displaying image content corresponding to the coordinate indicating apparatus at the predefined position on the touchscreen.

7. The method of claim 1, further comprising:
displaying image content corresponding to the coordinate indicating apparatus at a position of the touchscreen where the coordinate indicating apparatus is placed; and
as the coordinate indicating apparatus moves, moving the image content to a position where the coordinate indicating apparatus is moved.

8. The method of claim 1, further comprising:
assigning a sequence number to the coordinate indicating apparatus; and
selectively driving the coordinate indicating apparatus according to the assigned sequence number.

9. The method of claim 1, further comprising obtaining additional information about the coordinate indicating apparatus by recognizing a pattern of a conductive contact portion included in the coordinate indicating apparatus when the coordinate indicating apparatus contacts the touchscreen.

10. A touch input apparatus comprising:
a panel portion combined with a display and configured to sense touch information; and
a touch input apparatus controller configured to:
determine a contact position of a coordinate indicating apparatus with the panel portion by detecting a change in an electricity-storing device that occurs in the panel portion due to a contact with the coordinate indicating apparatus, and
obtain identification information on the coordinate indicating apparatus by transmitting an electromagnetic signal, as an energy source, to the coordinate indicating apparatus via the panel portion.

11. The apparatus of claim 10, wherein the touch input apparatus controller is configured to obtain the identification information by recognizing information on an electronic tag included in the coordinate indicating apparatus.

12. The apparatus of claim 10, further comprising an image processor configured to:
determine if the coordinate indicating apparatus is placed at a position on the panel portion that is predefined with respect to the coordinate indicating apparatus; and
output for display image content corresponding to the coordinate indicating apparatus at the predefined position when the coordinate indicating apparatus is determined to be placed at the predefined position on the panel portion.

13. The apparatus of claim 10, wherein the touch input apparatus controller is further configured to:
determine a sequence number to be recorded in the coordinate indicating apparatus;
transmit a response request signal that requests the coordinate indicating apparatus having the sequence number to provide a response; and
detect a response signal transmitted from the coordinate indicating apparatus having the sequence number in response to the transmitted response request signal.

14. The apparatus of claim 10, wherein:
the panel portion comprises a radio frequency (RF) transceiver configured to transceive an RF signal;
the RF transceiver comprises an antenna portion configured to receive an electromagnetic signal generated by the coordinate indicating apparatus and an RF transceiving controller configured to measure a signal received by the antenna portion; and
the RF transceiving controller is configured to transmit, via the antenna portion, a sequence number to be recorded in the coordinate indicating apparatus and a response request signal that requests the coordinate indicating apparatus having the sequence number to generate a response, to cause the coordinate indicating apparatus to change a state function thereof according to the sequence number and to determine a delay between the response request signal and a response signal, responsive to the response request signal, according to the state function.

15. The apparatus of claim 10, wherein, when the coordinate indicating apparatus comes into contact with the panel portion and then moves thereon, a state function of the coordinate indicating apparatus is maintained while the coordinate indicating apparatus moves on the panel portion.

16. The apparatus of claim 10, wherein, when the coordinate indicating apparatus comes into contact with the touch input apparatus, separates from the touch input apparatus, and approaches the touch input apparatus again after a predetermined time, the coordinate indicating apparatus generates the identification information.

17. The apparatus of claim 10, wherein the touch input apparatus controller is further configured to obtain additional information on the coordinate indicating apparatus by recognizing a pattern of a conductive contact portion included in the coordinate indicating apparatus when the coordinate indicating apparatus contacts the touchscreen.

18. A coordinate indicating apparatus configured to provide a touch input on a touch input apparatus, the coordinate indicating apparatus comprising:
a coordinate indicating apparatus controller configured to provide identification information of the coordinate indicating apparatus based on an electromagnetic signal, as an energy source, transmitted from the touch input apparatus; and
at least one conductive contact portion on a side of the coordinate indicating apparatus that contacts a touchscreen of the touch input apparatus when the coordinate indicating apparatus contacts the touchscreen.

19. The apparatus of claim 18, wherein the at least one conductive contact portion comprises two or more conductive contact portions, and at least one of the two or more conductive contact portions has a different size from other conductive contact portions of the two or more conductive contact portions.

20. The apparatus of claim 18, further comprising an electronic tag configured to transmit an electromagnetic signal indicating the identification information to the touch input apparatus based on the electromagnetic signal, as the energy source, transmitted from the touch input apparatus.

21. The apparatus of claim 18, wherein a pattern of the at least one conductive contact portion indicates, to the touch input apparatus, additional information on the coordinate indicating apparatus when the at least one conductive contact portion contacts the touchscreen.

22. A method of providing a touch input by a coordinate indicating apparatus on a touch input apparatus, the method comprising:
providing, to the touch input apparatus, identification information of the coordinate indicating apparatus based on an electromagnetic signal, as an energy source, transmitted from the touch input apparatus; and
contacting, by at least one conductive contact portion on a side of the coordinate indicating apparatus, a touchscreen of the touch input apparatus.

23. The method of claim 22, wherein the at least one conductive contact portion comprises two or more conductive contact portions, and at least one of the two or more conductive contact portions has a different size from other conductive contact portions of the two or more conductive contact portions.

24. The method of claim 22, wherein the providing the identification information comprises transmitting, by an electronic tag of the coordinate indicating apparatus, an electromagnetic signal indicating the identification information to the touch input apparatus based on the electromagnetic signal, as the energy source, transmitted from the touch input apparatus.

25. The method of claim 22, wherein a pattern of the at least one conductive contact portion indicates, to the touch input apparatus, additional information on the coordinate indicating apparatus when the at least one conductive contact portion contacts the touchscreen.
